(19) United States
(12) Patent Application Publication
(10) Pub. No.: US 2003/0064731 A1
(43) Pub. Date: Apr. 3, 2003

(54) Use of satellite positioning system to dynamically change the communication capability of an electronic device

(76) Inventors: Michael F. Angelo, Houston, TX (US); E. David Neufeld, Magnolia, TX (US); Sompong P. Olarig, Pleasonton, CA (US)

Correspondence Address: CONLEY ROSE, P.C., P. O. BOX 3267, HOUSTON, TX, 77253-3267, US

(21) Appl. No.: 09/966,648

(22) Filed: Sep. 28, 2001

(51) Int. Cl. G06F 9/00

(52) U.S. Cl. 455/456

(57) ABSTRACT

An electronic device can automatically configure its communication capability depending on its location. The device preferably includes a location determination module which may comprise, for example, a GPS receiver. The location determination module provides a location value to a CPU which uses the location value to determine in which region of the world (e.g., a country) the device is located. Based on that determination, the device configures its communication capability to be compliant with the accepted communication protocols, carrier frequency, etc. of that region.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to configuring electronic devices for use across the globe. More particularly, the invention relates to using a satellite positioning system to automatically configure an electronic device for use according to the requirements of the country in which the electronic device is located.

2. Background of the Invention

It goes without saying that electronic devices are desired to be used, and are used, in virtually every country on the globe. Such devices include desktop computers, portable computers, personal data assistants (“PDAs”), wireless devices such as PDAs, email devices (e.g., Compaq's Blackberry), cellular telephones, and the like.

There are some operational aspects of electronic devices that are specific to the particular country in which the device operates. One such operational aspect is the external communication capability of the device. For example, wireless devices can send and receive email and be used to browse the Internet. Wireless communication devices operate according to a predetermined communication protocol, such as Code Division Multiple Access (“CDMA”), Time Division Multiple Access (“TMDA”), and Global System for Mobile Communications (“GSM”). Each protocol generally specifies how data is packetized and formatted to transmit to and from the wireless device. The protocols may also specify a carrier frequency on which the information (voice, text, etc.) to be transmitted is modulated.

Generally, each country or region of the world has free reign to allocate the frequency spectrum as it sees fit and to specify the standard communication protocol for use in that region. As such, a particular frequency in one country may be available for a particular use, but in another country that same frequency may be reserved for a different use. Thus, a single common carrier frequency and communication protocol have not been adopted across the globe for wireless devices. These international differences mean that a wireless device designed to operate in one country may be completely useless in other countries. This limitation may force some users of such devices to have multiple devices, one for each country in which they intend to visit. Other users may simply choose to do without any device when traveling in certain countries. For obvious reasons, this approach is less than desirable from the user's vantage point. The user would prefer to be able to use one device anywhere in the world. Despite the advantages such a device would provide, no such device is known to exist.

### SUMMARY OF THE INVENTION

The problems noted above are solved in large part by an electronic device that can automatically configure its communication capability depending on its location. The device preferably includes a location determination module which may comprise, for example, a GPS receiver. The location determination module provides a location value to a CPU which uses the location value to determine in which region of the world (e.g., a country) the device is located. Based on that determination, the device configures its communication capability to be compliant with the accepted communication protocols, carrier frequency, etc. of that region.

The electronic device may have location-configuration data programmed into it to permit the device to determine its country based on a geographic location value provided by the location determination module. Alternatively, the electronic device can communicate with a location determination entity via a satellite. The location determination entity can correlate the location value provided by the device's location determination module to a specific country and provide the identity of the country to the device to use when configuring its communication capability.

The electronic device can be any type of device whose configuration or operation may need to be different between various regions of the world because of communication specific standards of the various regions. The device, for example, may be a PDA, cellular telephone, laptop computer, pager, modem, and the like.

These and other advantages will become apparent upon reviewing the following description and accompanying drawings.

### BRIEF DESCRIPTION OF THE DRAWINGS

For a detailed description of the preferred embodiments of the invention, reference will now be made to the accompanying drawings in which:

FIG. 1 shows a block diagram of an electronic device that includes a position location module that the device uses to configure itself for proper communication given the geographic location in which the device is located; and

FIG. 2 depicts one embodiment of a look-up table stored on the electronic device that the device uses to determine the proper communication settings for the location in which the device is located.

### NOTATION AND NOMENCLATURE

Certain terms are used throughout the following description and claims to refer to particular system components. As one skilled in the art will appreciate, computer companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect electrical connection. Thus, if a first device couples to a second device, that connection may be through a direct electrical connection, or through an indirect electrical connection via other devices and connections. Further, the term “region” is intended to generally refer to regions of the world for which a governing entity has specified communication standards. Generally, such regions will correspond to countries. Regions may also refer to groups of countries (e.g., Europe) for which a communication standard has been specified. To the extent that any term is not specially defined in this specification, the intent is that the term is to be given its plain and ordinary meaning.

### DETAILED DESCRIPTION OF THE PREFERRED EMBODIMENTS

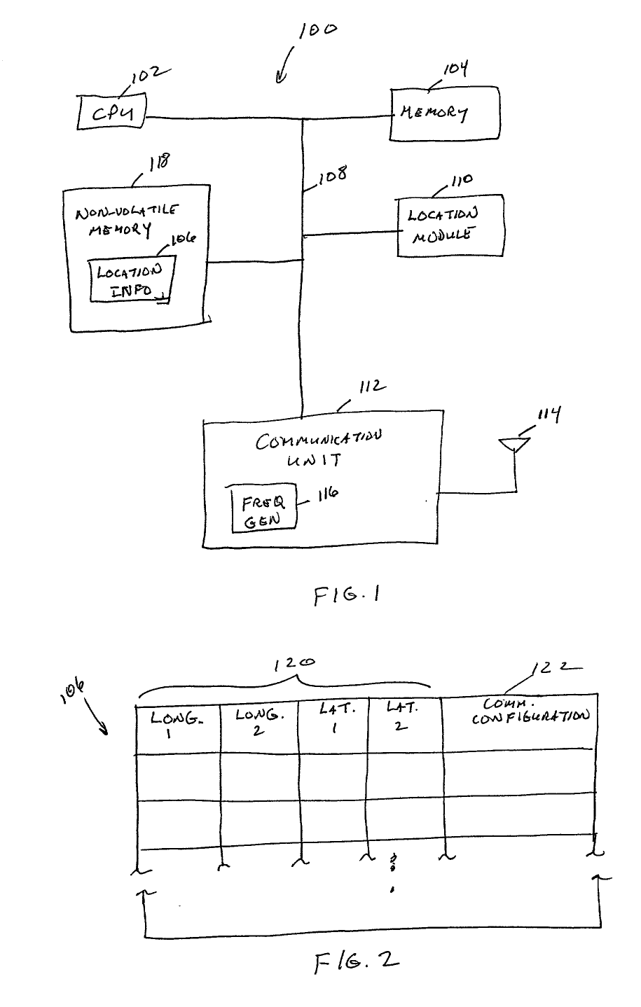

Referring now to FIG. 1, an electronic device 100 is shown constructed in accordance with a preferred embodiment of the invention. As shown, the device 100 includes a CPU 102, a volatile memory 104, a location module 110, a communication unit 112, and a non-volatile memory 118. The device 100 may be a PDA, a laptop or desktop computer, a wireless email device, a digital telephone (i.e., a cellular telephone), a modem, or any other type of electronic device noted above. Further, the device 100 may or may not be portable in nature. For example, the device may be a PDA or a desktop computer. One of ordinary skill in the art will recognize that other components may be included in device 100 to provide additional functionality unique to the device. For example, the device 100 may include a display, an input control device, and voice communication components such as a microphone and speaker in the case of a cellular telephone.

In the particular architecture shown in FIG. 1, the CPU 102 couples via bus 108 to memory 104, location module 110, communication unit 112, and non-volatile memory 118. Of course, a variety of other architectures for interconnecting these components can be used instead of the one shown in FIG. 1. The memory 104 preferably comprises any suitable type of random access memory (“RAM”) and is generally used to temporarily stored data and instructions to be executed by CPU 102 in accordance with known techniques. The non-volatile memory 118 comprises any type of memory that retains its contents even if the electronic device 100 is turned off. Suitable types of non-volatile memory 118 include a hard disk drive, read only memory (“ROM”), solid state disks, and the like. The non-volatile memory 118 preferably is used to store code that can be executable by the CPU 102 as well as store other types of information. As shown, the memory 108 includes storage 106 for location information which will be described in greater detail below.

The communication unit 112 includes or couples to an antenna 114. Together, the communication unit 112 and antenna 114 provide a wireless communication capability for the electronic device 100 through which any one or more of a variety of wireless activities can occur. Examples include email, paging text messages, two-way voice communications, Internet browsing, and the like. If desired, the device may have a wire-based communication link rather than wireless. Further, the communication protocol may be an optical-based protocol.

In accordance with the preferred embodiment of the invention, the electronic device 100 is capable of being configured to operate according to any one of a variety of communication protocols such as CDMA, TDMA, GSM, and the like. Each protocol is embodied in the executable code stored in the non-volatile memory 118 and executed by CPU 102. Further, any one of a variety of different carrier frequencies can be selected for use by the communication unit 112 as shown via the frequency generator 116 which may be part of the communication unit 112 or a separate component within the device 100. Different carrier frequencies can be selected by commands from the CPU 102 to the frequency generator 116.

Preferably, the CPU 102 can configure its communication capability by selecting a desired communication protocol and carrier frequency. The location module 110 performs the function of determining or otherwise providing location information to the CPU which the CPU uses to determine a suitable communication protocol and carrier frequency to use for the location in which the device 100 is located. The location module 110 can be any suitable type of component which provides or can be used to provide location information to the CPU 102. For example, the location module 110 may include a common global positioning system (“GPS”) receiver. As is well known, a GPS receiver examines signals from various GPS satellites orbiting the earth and uses those signals to determine the location of the receiver on the globe. The position information provided by location module 110 preferably is in the form of longitude and latitude values. Alternatively, the location module output data may be data that indicates the location of the receiver relative to the GPS satellites or relative to a predetermined point on the earth's surface.

In accordance with the preferred embodiment, upon activation, the CPU 102 causes the location module 110 to provide location information to the CPU. The CPU preferably uses the location information to determine in which country or region of the world that the device 100 is located. Once the CPU determines the region in which the device is located, the CPU then configures the device's communication capability in accordance with the communication standards of that country.

The location information storage 106 preferably comprises a look-up table which is shown in greater detail in FIG. 2. Each entry in the table corresponds to a region of the world. Further, the table 106 includes a plurality of location look-up values 120 for each region and a corresponding set of communication configuration requirements 122. As shown, there are four location look-up values 120 for each region, although there can by any suitable number of columns. If a country is substantially rectangular in shape, the set of geographic coordinates comprising the country can be determined based on its four edges—east and west longitude values and north and south latitude values. Thus, the four columns of location look-up values in table 106 are included to determine the four boundary edges in the case of a rectangular (or square) region. The CPU 102 can determine whether its current location (expressed in the same unit of measure as the location values in the table 106 such as a longitude and latitude coordinate) is within the boundaries of any region whose boundaries are defined in table 106 by determining whether the longitude value of the coordinate of the device is between the two longitude (longitude 1 and longitude 2) values in the table and also whether the device's latitude coordinate is between the two corresponding latitude values (latitude 1 and latitude 2). That is, the CPU 102 determines whether the device's location falls within the boundary of any one region defined in the table.

Of course, most regions are not simple squares or rectangles in shape. Accordingly, as one of ordinary skill in the art will appreciate, more location values may need to be added to table 106 for each region to be fully characterized geographically so that it can be determined whether a given coordinate is within the boundaries of an irregularly shaped region. Values 120 in the location information table 106 may contain values, formulas, equations, and other types of information for each country from which the CPU 102 can determine the region which corresponds to the location data provided by the device's location module 110. This disclosure is intended to encompass any technique for an electronic device to determine in which region of the world the device is currently located.

As a variation to the embodiment described above, for example, the CPU 102 could receive the location value from the location module 110 and provides that value to an external country location determination entity such as an on-line service accessible via a satellite. Using a satellite (which may require the device 100 to include a suitable antenna not shown in FIG. 1) for access to the aforementioned country location determination entity, means that the device 100 can communicate with the satellite using the same communication protocol regardless of where the device is located. That is, this type of communication is not a function of the communication protocol/frequency of each region and can occur even though the device may not yet be configured for communication in the country where it is located. The device 100 can transmit its location value to the country location determination entity, which receives the location value for the device and makes its own determination as to the region in which the device is located. This determination can be made as described above with regard to FIG. 2 or via any other manner known to those of ordinary skill in the art. Once the location determination has been made, the country location determination entity informs the device as to which country it is located. This process alleviates the device 100 from having to determine its country.

Once the CPU 102 determines its country, the CPU configures its communication capabilities using the communication configuration information 122. The communication configuration information may specify any one or more of a variety of communication specific parameters such as transmission carrier frequency, communication protocol and the like. For example, if a certain carrier frequency is needed, the CPU 102 commands the frequency generator 116 to generate the desired frequency for use by the communication unit 112. The various communication protocols generally specify the format of data packets (header information, footer information, size of the packet, error correction, etc.). The architecture of FIG. 1 is intended to be generic enough that it could be used to implement any desired communication protocol now known or later developed. It is the general function of the executable code in the non-volatile memory 118 to implement a desired protocol. The executable code that the non-volatile memory 118 contains thus permits the CPU 102 to configure its communication capability according to a plurality of communication standards, and even all of the communication standards currently used in the world. As more standards are promulgated by certain countries or existing standards are changed, the device's non-volatile memory 118 can be loaded with appropriate updated code to include such additions or changes.

It should also be understood that device 100 may include a network processor, in addition to CPU 102, to perform the function of a communication engine. Such a processor may be included instead of, or in addition to, communication unit 112.

Thus, the electronic device 100 can be used in different areas of the world, even areas that require disparate communication protocols to be used. The device automatically determines where it is located, which communication protocol is suitable for that area and configures itself for operation in that area. As described above, the transmission carrier frequency and communication protocol can be selected according to location. Other facets of the device's operation can also be selected based on location. Such other facets include configuring a modem for proper operation in a given location, such as by adjusting its frequency and/or communication protocol.

For additional information regarding satellite based location devices, please consult U.S. Pat. No. 6,125,446, entitled “Computer Architecture With Automatic Disabling Of Hardware/Software Features Using Satellite Positioning Data” and U.S. Pat. No. 5,635,940, entitled “Communication Configuration And Method For Implementing Same,” both of which are incorporated herein by reference.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An electronic device, comprising:
a CPU;
a location module coupled to said CPU; and
a communication unit coupled to said CPU;
wherein said CPU receives a location value from said location module, determines a region of the world in which the electronic device is located based on said location value and configures a communication capability for the electronic device based on the determined region.

2. The electronic device of claim 1 wherein said location module comprises a GPS receiver.

3. The electronic device of claim 1 wherein when said CPU configures the communication capability, said CPU configures the communication unit to operate in accordance with one of a plurality of communication protocols.

4. The electronic device of claim 1 wherein when said CPU configures the communication capability, said CPU configures the communication unit to operate in accordance with one of a plurality of transmission carrier frequencies.

5. The electronic device of claim 1 further including non-volatile memory coupled to said CPU, said memory storing location information, said location information including location data and communication configuration values pertaining to said location data.

6. The electronic device of claim 1 further including non-volatile memory coupled to said CPU, said memory storing a look-up table having a plurality of entries, each entry pertains to a different region and each entry includes location information and communication configuration values pertaining to said location data.

7. The electronic device of claim 6 wherein said location information in each entry comprises a plurality of longitude values.

8. The electronic device of claim 6 wherein said location information in each entry comprises a plurality of latitude values.

9. The electronic device of claim 6 wherein said location information in each entry comprises a plurality of longitude and latitude values.

10. The electronic device of claim 6 wherein said communication configuration values specify a communication protocol.

11. The electronic device of claim 6 wherein said communication configuration values specify a transmission carrier frequency.

12. The electronic device of claim 6 wherein said communication configuration values specify a communication protocol and a transmission carrier frequency.

13. The electronic device of claim 1 wherein said region is a country.

14. The electronic device of claim 1 wherein said location value received from said location module comprises longitude and latitude values.

15. The electronic device of claim 1 wherein said CPU receives said location value from said location module when power is enabled to said electronic device.

16. The electronic device of claim 1 further including non-volatile memory coupled to said CPU and containing code which can be accessed and executed by said CPU, said code includes instructions permitting said CPU to configure the communication capability based on the determined region in which the electronic device is located.

17. The electronic device of claim 1 wherein said electronic device comprises a wireless communication device.

18. The electronic device of claim 1 wherein said electronic device comprises a PDA.

19. The electronic device of claim I wherein said electronic device comprises a laptop computer.

20. The electronic device of claim 1 further including a microphone and speaker coupled to said CPU and wherein said electronic device comprises a cellular telephone.

21. The electronic device of claim 1 further including a modem and said communication capability comprises the modem's frequency.

22. The electronic device of claim 1 further including a modem and said communication capability comprises the modem's communication protocol.

23. An automatic method of configuring the communication capability of an electronic device, comprising:
(a) receiving a location value pertaining to the location of the electronic device; and
(b) configuring a communication capability for the electronic device based on the received location value.

24. The method of claim 23 further including determining a region of the world in which the electronic device is located based on said location value and (c) includes configuring the communication capability for the electronic device based on the determined region.

25. The method of claim 24 wherein said region comprises a country.

26. The method of claim 23 wherein (a) includes receiving a location value from a GPS receiver.

27. The method of claim 23 wherein (b) includes configuring the electronic device to operate in accordance with one of a plurality of communication protocols.

28. The method of claim 23 wherein (b) includes configuring the electronic device to operate in accordance with one of a plurality of transmission carrier frequencies.

29. The method of claim 23 wherein (b) includes comparing said location value to a look-up table of location and configuration data to determine in which region of the world the electronic device is located and which communication capability works in that region.

30. The method of claim 29 wherein the location data in the look-up table includes a plurality of longitude values.

31. The method of claim 29 wherein the location data in the look-up table includes a plurality of latitude values.

32. The method of claim 29 wherein the location data in the look-up table includes a plurality of longitude and latitude values.

33. The method of claim 29 wherein the configuration data in said look-up table comprises transmission carrier frequencies.

34. The method of claim 29 wherein the configuration data in said look-up table comprises communication protocols.

35. The method of claim 29 wherein the configuration data in said look-up table comprises transmission carrier frequencies and communication protocols.

36. The method of claim 23 wherein (a) is performed upon powering up the electronic device.

37. The method of claim 23 wherein said electronic device comprises a wireless communication device.

38. The method of claim 23 wherein said electronic device comprises a PDA.

39. The method of claim 23 wherein said electronic device comprises a laptop computer.

40. The method of claim 23 wherein said electronic device comprises a digital telephone.

41. The method of claim 23 wherein said communication capability includes a modem's frequency.

42. The method of claim 23 wherein said communication capability includes a modem's communication protocol.

43. An electronic device, comprising:
a CPU;
a display having an adjustable raster rate coupled to said display; and
a location module coupled to said CPU;
wherein said CPU automatically configures the raster rate of said display based on a location value received from said location module.
